(19) United States
(12) Patent Application Publication
(10) Pub. No.: US 2002/0165987 A1
(43) Pub. Date: Nov. 7, 2002

(54) Digital contents watching method and its system

(75) Inventors: Takeshi Arisaka, Tokyo (JP); Nobuya Okayama, Tokyo (JP); Hiroshi Koike, Tokyo (JP); Miyoko Namioka, Tokyo (JP); Tatsuro Arai, Tokyo (JP)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: Hitachi, Ltd., Tokyo (JP)

(21) Appl. No.: 10/119,989

(22) Filed: Apr. 9, 2002

(30) Foreign Application Priority Data
Apr. 24, 2001 (JP) 2001-130597

(51) Int. Cl. G06F 15/16

(52) U.S. Cl. 709/246; 709/231

(57) ABSTRACT

The invention provides a personalized playback continuation system for digital content that allows continuation of content playback even when the user is at a different location or a different playback terminal. For each user, a server manages a personal playback action history, e.g., which content was played back up to which point. If playback is interrupted, playback continuation information for the content at that point in time is sent from the playback terminal device to the server and stored in the personal playback action history. When an interrupted content playback is resumed, the server uses the personal playback action history and the content information describing the properties of the content to generate playback start information, which is sent to the playback terminal. If the terminal type of the playback terminal does not match the content type of the digital content indicated by the content identifier, the content is converted to match the terminal type of the playback terminal, and playback continuation information associated with the converted content is generated.

### CROSS-REFERENCES TO RELATED APPLICATIONS

The present application is related to and claims priority from Japanese Patent Application No. 2001-130597 filed Apr. 27, 2001.

### BACKGROUND OF THE INVENTION

The present invention relates to a technology that allows a user to play back digital content.

An example of a playback terminal device that can be shared by a plurality of users is the personal electronic book device from Japanese laid-open patent publication number Hei 9-101971. In this technology, multiple users can make their own personal markings on different sections in books. The marking information is stored in the device, and content is obtained from the device or a server.

An example of electronic book technology that allows interrupted reading to take place at the point of interruption is the Electronic Book Consortium's books-on-demand composite experiment, where content and bookmark information are stored in the same media and books can be read from different locations from where reading was last interrupted if the same type of reading terminal is used.

Also, a technology is available to distribute content in formats suited for individual terminals. When pages are requested from different types of terminals, e.g., portable phones and personal computers from different manufacturers, terminal type information (e.g., personal computer, portable phone) sent along with the page request is evaluated and content (in HTML or HDML format or the like) suited for the terminal type is dynamically generated and sent to the terminal.

### SUMMARY OF THE INVENTION

The present invention provides a digital content playback method in a digital content playback system including a terminal allowing a user to play back digital content and a data management device managing digital contents. The following operations are performed in accordance with an embodiment of the invention:

(1) The terminal receives user identification information of a user and digital content identification information played back by the user, and the user identification information and content identification and content types capable of being played back by the terminal are sent to the data management device;

(2) The data management device stores the digital contents in association with the digital content identification information, stores the user identification information in association with a start position at which the user will start playback, receives from the terminal the user identification information and the content identification information and the terminal identification information and the received content types capable of being played back by the terminal, converts the received digital content identification information and the stored digital content associated with the received content type to the received content type, and outputs to the terminal the converted digital content and a playback action history associated with the received user identification information;

(3) The terminal also receives the playback action history output and the digital content output, and outputs information based on the playback action history.

As a result, a user can resume content playback from different locations and different playback terminals.

### BRIEF DESCRIPTION OF THE DRAWINGS

The teachings of the present invention can be readily understood by considering the following detailed description in conjunction with the accompanying drawings:

FIG. 1 is a sequence diagram showing the series of steps performed in a digital content playback system according to an embodiment of the present invention;

FIG. 2 is a simplified drawing showing the architecture of a digital content playback system 200 according to an embodiment of the present invention;

FIG. 3 is a simplified drawing showing the architecture of a playback data management device 210 according to an embodiment of the present invention;

FIG. 4 is a simplified drawing showing the architecture of a playback terminal device 220 according to an embodiment of the present invention;

FIG. 5 is a drawing showing a sample playback action history 500 according to an embodiment of the present invention;

FIG. 6 is a drawing showing a sample terminal type 421 according to an embodiment of the present invention;

FIG. 7 is a drawing showing a sample content information 423 according to an embodiment of the present invention;

FIG. 8 is a flowchart showing the sequence of operations performed by a content conversion processing module 314 of a playback data management device 210 according to an embodiment of the present invention;

FIG. 9 is a flowchart showing the sequence of operations performed by a playback start information generation processing module of a playback data management device 210 according to an embodiment of the present invention;

FIG. 10 is a flowchart showing the sequence of operations performed by a playback start information generation processing module of a playback data management device 210 according to an embodiment of the present invention; and

FIG. 11 is a simplified drawing showing the architecture of the digital content playback system 200 according to an embodiment of the present invention.

### DESCRIPTION OF THE SPECIFIC EMBODIMENTS

First, a brief discussion of the various aspects of the present invention is presented. In recent years, the distribution of digital content has become more active. With digital content such as videos, CDs, and books belonging to a comic cafe or a library, the user expects to be able to playback the digital content using the playback terminal installed at the comic cafe or the library. The various embodiments of the present invention address user expectations of being able to interrupt playback of digital content and be able to continue playback at the next visit or at another establishment. It is expected there will also be a demand for continuation playback between playback terminals of different types. For example, a user may want to read a multimedia book via the Web using a personal computer at home, continue reading the book in a text format from an electronic book terminal at a hospital, and then continue the book while in a train via audio from an audio terminal.

The inventors have recognized that in the personal electronic book device that can be shared by a plurality of users, marking information are not persistent if a different electronic book device is used. Thus, continuation playback is difficult.

The inventors have recognized that with electronic books that allow continued reading, the playback device must be able to read from and write to a recording medium. Thus, if the playback terminal is not able to read from or write to a recording medium, continued reading is not possible. Also, there is a limit to the amount of information that can be stored in a recording medium. Thus, continued playback of content that exceeds this limit is difficult.

The inventors have further recognized that conventional techniques are available for changing distributed content based on the type of playback terminal. However, such techniques do not to provide continual playback. This makes continual playback based on the type of playback terminal difficult.

Following is a description of a digital content playback method and system according to an embodiment of the present invention. The digital content referred to here includes digitized content such as electronic books, music, video, games, and the like. Digital content may also be referred to simply as content.

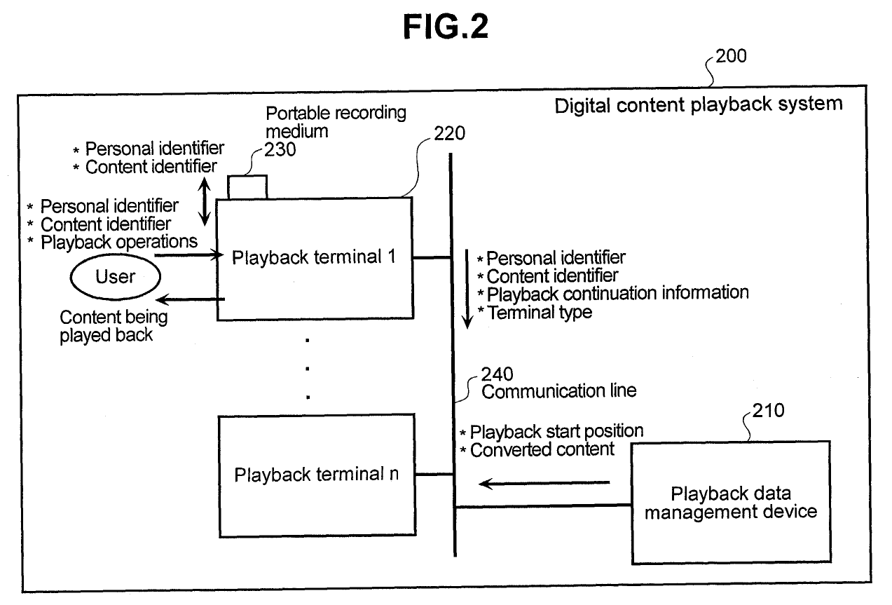

FIG. 2 shows a simplified drawing of the architecture of a digital content playback system according to this embodiment. As shown in FIG. 2, a digital content playback system 200 includes a playback data management device 210 (typically configured as a server system), at least one playback terminal device 220, a portable storage medium 230, and a communication line 240. If the playback terminal device 220 does not read from or write to portable storage media, the portable storage medium is omitted.

The playback terminal device 220 receives an individual identifier and content identifier from the user or the portable storage medium 230. The playback terminal device 220 provides the user with content and responds to playback operations.

The playback data management device 210 receives content identifiers, playback continuation information, and terminal types (terminals are set up with information indicating content types that can be displayed by the terminals or content types that users would like to play back) from the playback terminal device 220 via the communication line 240. The playback data management device 210 sends playback start information and converted content to the playback terminal device 220.

The portable storage medium 230 is a storage medium that can store digitized information, e.g., an IC card or smart media. The portable storage medium 230 stores an individual identifier and a content identifier. Individual information and the like can also be stored.

The communication line 240 is an information transfer path that allows digitized information to be sent and received between the playback data management device 210 and the plurality of playback terminal devices 220. The communication line 240 does not have to be a single communication line and different types of lines and line capacities can be used based on the scale of the digital content playback system. Also, multiple types of lines can be used through a circuit switching device. In this case, the communication line 240 would include the circuit switching device.

Next, the overall flow of operations will be described using FIG. 2. The system user wanting to playback digital content uses a keyboard or the like to enter an individual identifier into the playback terminal device. Alternatively, the individual identifier can be entered in the playback terminal device by inserting a portable storage medium containing the individual identifier into the playback terminal device. The content identifier of the digital content to be played back is entered. The digital contents available to the user for playback can be provided to the user in the form of a list on paper or displayed on the playback terminal device.

Next, the playback terminal device sends the playback data management device terminal type information indicating the digital content playback capabilities of the device, the individual identifier, and the content identifier. Using this data, the playback data management device generates playback start information, indicating whether playback of the digital content is to start at the beginning or at an intermediate point, and content converted to suit the terminal type. The playback terminal device uses this data to play back the digital content and handles standard playback operations from the user such as pause, play, stop, end, and the like.

If the playback terminal device receives from the user an operation for stopping content playback, e.g., pause or stop, playback continuation information indicating the status of content playback at that moment is generated and sent to the playback data management device. The playback data management device stores the playback continuation information in a database or the like. The digital content playback system 200 provides interruptible playback of digital content for the user based on the flow of operations described above.

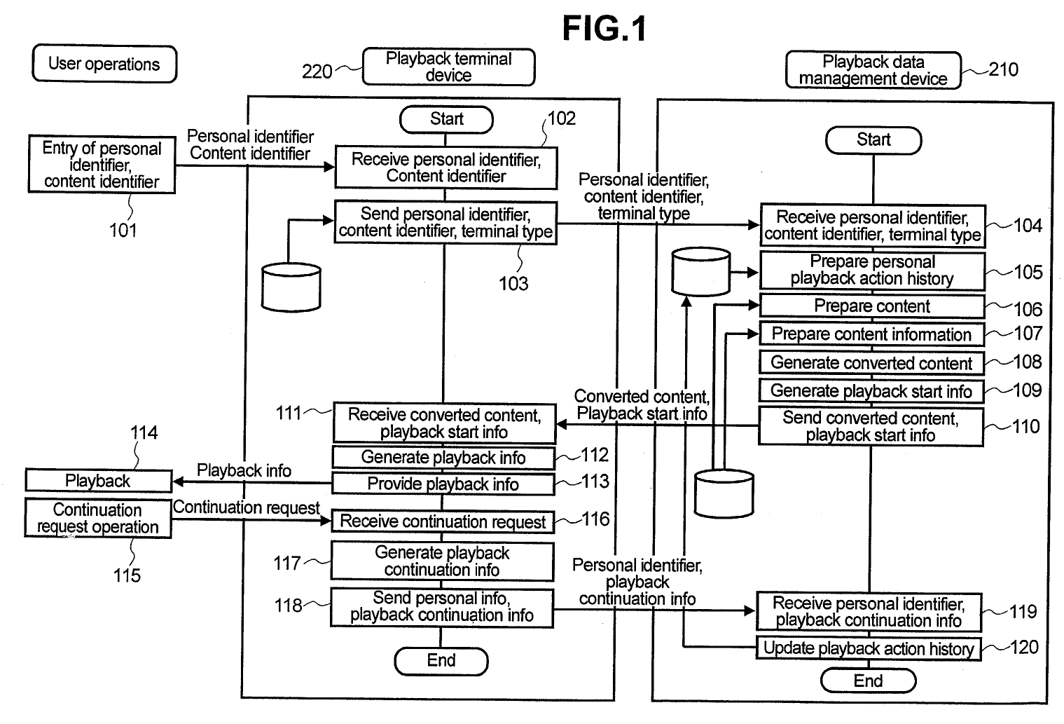

Next, the flow of operations will be described in detail using FIG. 1. FIG. 1 is a sequence diagram showing the series of operations performed by the digital content playback system according to an embodiment of the present invention.

Step 101: The digital content user (the user of the digital content playback system) enters an individual identifier and a content identifier in the playback terminal device 220. Alternatively, this information can be entered from the portable storage medium 230. Different types of input means can be used according to the type of playback terminal.

If a personal computer is used, input means will generally be a keyboard. It would also be possible to automatically enter the individual identifier and the content identifier by inserting an IC card containing individual information into a card insertion slot of the terminal. Input via voice or touch-panels is also possible. After this input operation, it would be practical to include a step for authenticating the individual identifier. It is possible for this step 101 to be divided into a step for input of the individual identifier and a step for input of the content identifier. For example, after the individual identifier is entered, the playback terminal can use a CRT or the like to output a list of contents available for playback to the user indicated by the individual identifier. The user would then select content from this list.

Step 102: The playback terminal device 220 receives the individual identifier and the content identifier from the user.

Step 103: In order to obtain playback start information, the playback terminal device 220 uses the communication line 240 to send the individual identifier and the content identifier from the user to the playback data management device 210. It would also be possible to send a terminal type 421 to the playback data management device 210 as well so that converted content can be obtained. FIG. 2 shows one server, but the present invention can also be implemented for multiple servers. Step 102 can also be divided into a step for obtaining converted content and a step for obtaining playback start information.

Step 104: The playback data management device 210 receives the individual identifier and the content identifier from the playback terminal device 220 via the communication line 240. It may also receive the terminal type 421 from the playback terminal device 220 via the communication line 240.

Step 105: Using the individual identifier and the playback action history received from the playback terminal device 220 via the communication line 240, the playback data management device 210 obtains a personal playback action history associated with the individual identifier.

Step 106: Using the content identifier received from the playback terminal device 220 via the communication line 240, the playback data management device 210 prepares the content associated with the content identifier.. Various types of preparation methods can be used, e.g., retrieving data recorded in the playback data management device 210 or retrieving content from a remotely located digital content storage server via a communication line. This step can be eliminated if there is no terminal type.

Step 107: Using the content identifier received from the playback terminal device 220 via the communication line 240, the playback data management device 210 prepares content information associated with the content identifier. Various types of preparation means can be used, e.g., retrieving data recorded in the playback data management device 210 or retrieving content information from a remotely located digital content information storage server via a communication line.

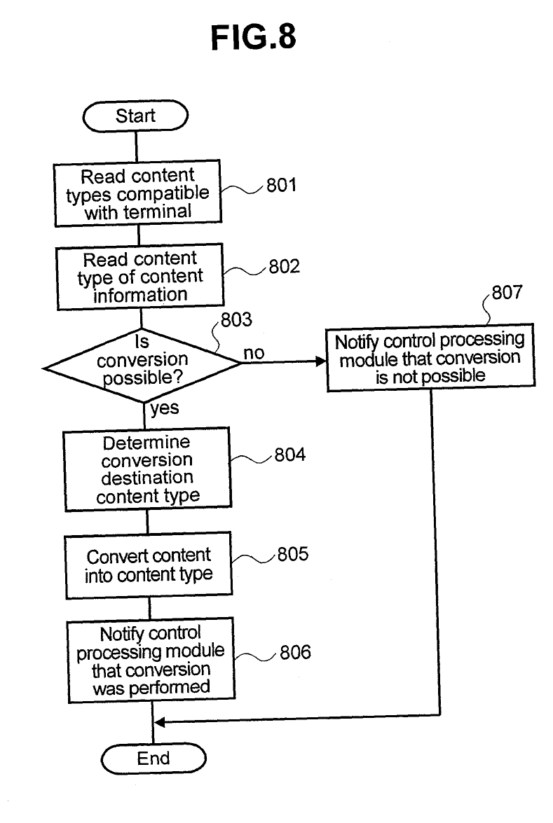

Step 108: If terminal type information is received from the playback terminal device 220 via the communication line 240, the playback data management device 210 converts the content prepared at step 106 for the terminal type, thus generating converted content. For example, if the playback terminal device 220 can only output text information, content that includes both text and images is converted to text-only content. If a terminal can only output audio information, text information is converted to audio information. The video information being ignored for the purpose of conversion, so that less that all of the content is converted. The generation of converted content will be described in detail using FIG. 8.

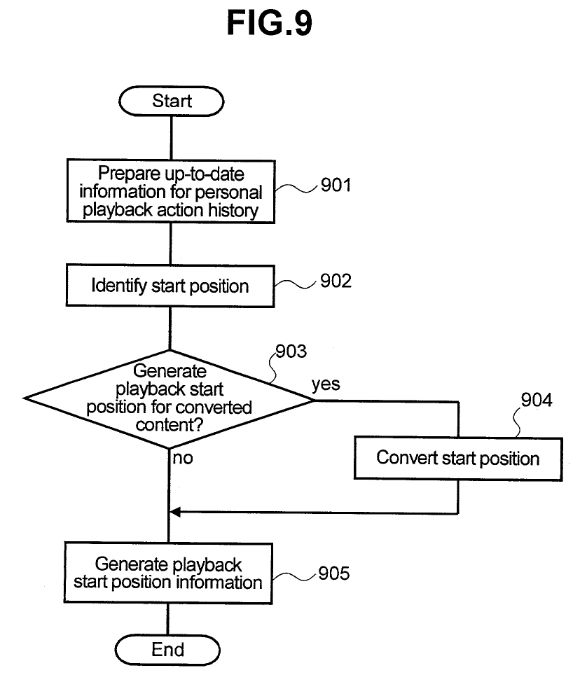

Step 109: Using the individual playback action history of the user obtained at step 105 and the content information obtained at step 107, the playback data management device 210 generates playback start information, which is needed for resuming playback. The playback start information includes up-to-date individual playback action history associated with the content. If terminal type information is received at step 104, the up-to-date individual action history information for the content is converted for the terminal type. Also, it would be practical to include information relating to content playback. This information relating to content playback can be, for example, digitized information relating to sound volume settings in the case of an audio playback terminal, or digitized color density, contrast or the like in the case of a video playback device. Playback start information generation will be described in detail using FIG. 9.

Step 110: The playback data management device 210 uses the communication line 240 to send to the playback terminal device 220 the playback start information obtained at step 109 and, if the terminal type was received at step 104, the converted content obtained at step 108. It would also be possible to send the playback terminal device 220 the content at the start position indicated in the playback start information. In this case, the playback start information does not need to be sent to the playback terminal device 220. In this manner, different modes can be set up for sending content starting at a start position and sending all content. This mode information can be input from the playback terminal device 220 and the playback data management device 210 can select one of the modes.

Step 111: The playback terminal device 220 uses the communication line 240 to receive from the playback data management device 210 the playback start information and, if the terminal type was sent at step 103, the converted content obtained at step 108.

Step 112: Using the playback start information obtained at step 111 as well as the converted content if the terminal type was sent at step 103 or the content if no terminal type was sent, the playback terminal device 220 generates playback information. This playback information includes digitized information prompting the user for playback-related operations and information to be provided to the user to allow playback of the content or converted content based on the playback start information. If the content sent as described above is content for the start position indicated by the playback start information, the playback information is generated from the start of the content. Similarly, if the content is being played back to the user for the first time, the playback information is generated from the start.

Step 113: The playback terminal device 220 provides the user with the playback information generated at step 112. Different methods are used depending on the type of output device of the playback terminal device 220. For example, image and text information is displayed on a CRT if the playback terminal device 220 is a personal computer, and audio information is played back if the playback terminal device 220 is an audio playback device.

Step 114: The user is provided with the playback information from the playback terminal device 220. Different types of playback-related operations are available based on the content. In general, operations such as playback, fast forward, rewind, pause, stop, exit, and seek are available.

Step 115: The user issues a continuation request to the playback terminal, e.g., in a pause operation. Depending on the system, the user may not need to explicitly make a continuation request, e.g., an exit instruction can be considered as a continuation request.

Step 116: The playback terminal device 220 receives the continuation request from the user. As in step 101, the method used to receive the playback operation depends on the type of playback terminal device 220. The user may not need to explicitly make a continuation request, e.g., an exit instruction can be considered as a continuation request.

Step 117: The playback terminal device 220 generates playback continuation information. The playback continuation information is digitized information indicating the position up to which the content had been played back. It includes at least information similar to the up-to-date user playback action history for the content as described in step 109. It would also be possible to include information relating to content playback, e.g., digitized information relating to the volume setting in the case of an audio playback terminal or settings such as color density and contrast in the case of a video playback device.

Step 118: The playback terminal device 220 uses the communication line 240 to send the playback data management device 210 the individual identifier, the content identifier, and the playback continuation information so that the individual playback action history can be updated.

Step 119: The playback data management device 210 receives the individual identifier, the content identifier, and the playback continuation information from the playback terminal device 220 via the communication line 240.

Step 120: Using the individual identifier, the content identifier, and the playback continuation information received via the communication line 240, the playback data management device 210 updates the personal playback action history indicated by the personal identifier. If the terminal type was received at step 104, the playback continuation information can be converted to match the terminal type. The updating of information refers to insertion and re-writing of information.

FIG. 8 is a flowchart showing the flow of operations performed by the content conversion processing module 314 of the playback data management device 210. At step 801, the terminal type is used to obtain a list of content types that can be played back by the terminal. Content types refer to digitized information indicating types and properties of content. Based on the content information, a list of content types to which the content can be converted is obtained at step 802. At step 803, the list of content types obtained at step 802 and the list of content types obtained at step 801 are used to determine if the content type can be converted to a format that is suitable for play back on the terminal. If there is no content type that can be played back, this is indicated to the control module at step 807. If there is a content type that can be played back, a content type is determined at step 804. At step 805, the content is converted to the content type obtained at step 804, and the control processing module is notified that this conversion has taken place at step 806. The processing module 314 can therefore allows a terminal device of a first content type to present digital content of another content type to a user.

FIG. 9 is a flowchart showing the flow of operations performed by a playback start information generation processing module 316 of the playback data management device 210. At step 901, a personal playback action history 510 and the content identifier are used to read up-to-date information 511. At step 902, the playback start position is obtained from the up-to-date playback action history information 511 for the content. The playback start position is a digitized code sequence indicating the position information for the content. Step 903 determines whether playback start information is to be generated for converted content. If the content is converted content, the playback start position is converted using the content type of the original content and the content type of the converted content, step 904. For example, if and electronic book was converted to audio content, a playback start position at the first paragraph of the ninth page is converted to a playback start position at X minutes, Y seconds. At step 905, the playback start position, the content type, and the like obtained from the above step are used to generate playback start position information.

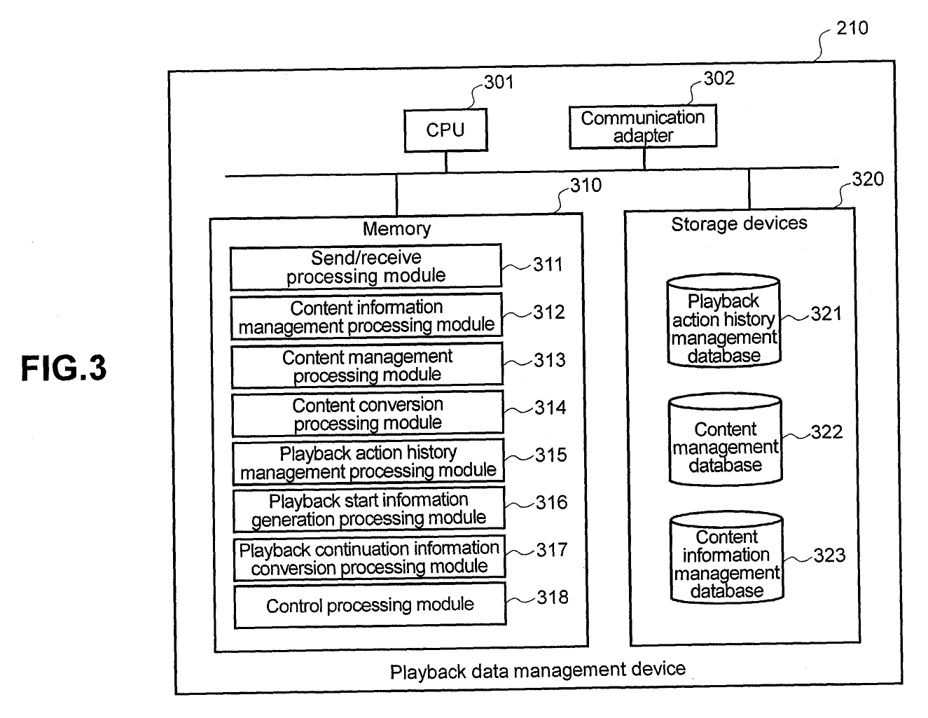

FIG. 3 is a simplified drawing of the architecture of the playback data management device 210 according to this embodiment. As shown in FIG. 3, the playback data management device 210 is formed from a CPU 301, a communication adapter 302, a memory 310, and a storage device 320.

The CPU 301 is a control device controlling the overall operations of the playback data management device 210. The communication adapter 302 is a device for sending and receiving digitized information to and from other devices. The communication adapter 302 communicates with the playback terminal device 220. The memory 310 is a storage device storing programs and data for various operations used to control the operations of the playback data management device 210. The storage device 320 is a storage device, e.g., a magnetic disk, storing the various programs, playback action histories, and, in some cases, digital content.

The playback data management device 210 includes: a send/receive processing module 311; a content information management processing module 312; a content management processing module 313; a content conversion processing module 314; a playback action history management processing module 315; a playback start information generation processing module 316; a playback continuation information conversion processing module 317; and a control processing module 318.

The send/receive processing module 311 uses the communication adapter 302 to send and receive information to and from the playback terminal device 220 via the communication line 240.

The content information management processing module 312 loads content information to the memory 310. The content information is read from a content management database in the storage device 320. Instead of this means, it would also be possible to use means involving obtaining the information from another device via a communication line. The content management processing module 313 loads the content into the memory 310. The content is read from the content database in the storage device 320. Instead of this means, it would also be possible to use means involving obtaining the content from another device via a communication line. If the content does not fit in the memory 310, the content can be split up and stored in the storage device 320, with only necessary sections being loaded into the memory 310.

The content conversion processing module 314 uses the content loaded in the memory 310 by the content management processing module 313 to generate converted content based on the terminal type and the content information. The converted content is loaded into the memory 310. If the content does not fit in the memory 310, the content is split up and stored in the storage device 320, with necessary sections being loaded into the memory 310, converted, and stored in the storage device 320.

The playback action history management processing module 315 retrieves from the playback information management database the personal playback action history of the user indicated by the personal identifier and loads this information in the memory 310. Also, the playback information management database is updated with information relating the personal playback action history in memory.

The playback start information generation processing module 316 generates playback start information using the personal playback action history of the user loaded from the memory 310 by the playback action history management processing module 315 and the content information loaded in the memory 310 by the content information management processing module 312. This playback start information is loaded in the memory 310.

The playback continuation information conversion processing module 317 retrieves information relating to personal playback action history from the playback continuation information and loads this in memory. If the content that had been played back was converted content, the history information is converted into a format suited for the pre-conversion content.

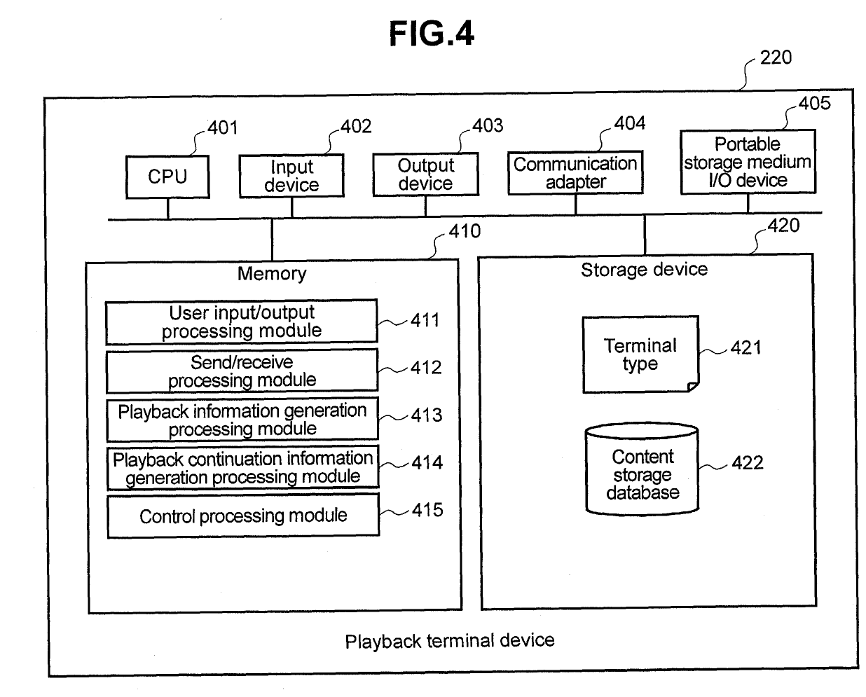

The playback continuation information conversion processing module 317 provides overall control for the playback terminal device 220, e.g., the various processing modules in the memory 410 and the storage device 420 (see FIG. 4).

A playback action history management database 321 manages the personal identifier and the personal playback action history associated with the user.

A content management database 322 manages the content identifier and the digital content itself indicated by the content identifier.

A content information management database 323 manages the content identifier and content information, i.e., supporting information relating to the content itself identified by the content identifier.

The programs that implement the send/receive processing module 311, the content information management processing module 312, the content management processing module 313, the content conversion processing module 314, the playback action history management processing module 315, the playback start information generation processing module 316, the playback continuation information conversion processing module 317, and the control processing module 318 in the playback data management device 210 are loaded into the storage device 320 from a storage medium such as a CDROM and then loaded into the memory 310 and executed. The medium used to store these programs can be a medium other than CD-ROM, e.g., DVD or DAT. Also, the programs can be loaded into the storage device 320 from another device via the communication adapter 302.

FIG. 4 is a simplified drawing of the architecture of the playback terminal device 220 according to this embodiment. As shown in FIG. 4, the playback terminal device 220 is formed from: a CPU 401, an input device 402, an output device 403, a communication adapter 404, a portable storage medium I/O device 405, a memory 410, and a storage device 420.

The CPU 401 is a control device providing overall control of the playback terminal device 220. The input device 402 is a device receiving and digitizing information from a user and can be, for example, a keyboard, an voice input device, a touch panel, or the like. The output device 403 converts digitized information into a form that can be understood by the user and transmits this information to the user. The output device 403 plays back content to the user and prompts the user for playback operations. The output device 403 can be a speaker, a vibration device, or the like. The communication adapter 404 is a device for sending and receiving digitized information to and from an other device. The communication adapter 404 sends and receives information to and from the playback data management device 210. The portable storage medium I/O device 405 is a device for reading and writing information to the portable storage medium 230 and can be, for example, an IC card reader/writer, a smart card reader/writer, or the like. The memory 410 is a storage device that stores various processing programs and data for controlling the operations of the playback terminal device 220. The storage device 420 is a storage device, e.g., a magnetic disk, that stores various processing programs, playback action histories, and, in some cases, digital content.

The playback terminal device 220 includes: a user input/output processing module 411; a send/receive processing module 412; a playback information generation processing module 413; a playback continuation information generation processing module 414; and a control processing module 415.

The user input/output processing module 411 loads the information entered by the user from the input device 402 into the memory 410. In some cases, the portable storage medium I/O device 405 can be used to enter the information from the portable storage medium 230. Also, the playback information generated by the playback information generation processing module 413 is converted to an a format that can be output by the output device if necessary and then output from the output device, thereby providing playback for the user and prompting the user for playback operations.

The send/receive processing module 412 uses the communication adapter 404 and sends and receives information to and from the playback data management device 210 via the communication line 240. The received information is loaded into the memory 410 or stored in the storage device 420.

The playback information generation processing module 413 uses playback start information and converted content information obtained by the send/receive processing module 412 or content obtained by itself to generate digitized information to be played back for the user. This information and information prompting for playback operations are combined to form playback information, which is loaded into the memory 410. Different methods can be used to obtain the content. For example, the content can be provided by the content storage database or can be received from the playback data terminal device. The playback information generation processing module 413 updates the playback information based on operation information entered by the user via the user input/output processing module.

The playback continuation information generation processing module 414 generates playback continuation information using information loaded into the memory 410 by the user input/output processing module and playback information generated and updated by the playback information generation processing module 413. This playback continuation information is loaded into the memory 410. The playback continuation information is digitized information associated with the interruption of playback, e.g., the point up to which the content was played back.

The control processing module 415 provides overall control of the playback terminal device 220, e.g., the different processing modules in the memory 410 and the storage device 420.

The terminal type 421 is digitized information of the characteristics of the playback terminal device 220 and is stored in the storage device 420. The terminal type 421 restricts the content types that can be played back on the playback terminal device 220. For example, if the terminal type 421 contains information indicating that only audio output is available, this indicates that the playback terminal device 220 is a device that is only equipped with voice output and cannot play back visual content.

A content storage database 422 stores converted content received from the playback data management device 210 and exists primarily to serve as a cache for transfers with the playback data management device 210 and to store information when the converted content cannot fit in the storage device 420.

The programs that implement the user input/output processing module 411, the send/receive processing module 412, the playback information generation processing module 413, the playback continuation information generation processing module 414, and the control processing module 415 in the playback data management device 210 are loaded into the storage device 420 from a storage medium such as a CD-ROM and then loaded into the memory 410 and executed. The medium used to store these programs can be a medium other than CD-ROM, e.g., DVD or DAT. Also, the programs can be loaded into the storage device 404 from another device via the communication adapter 404.

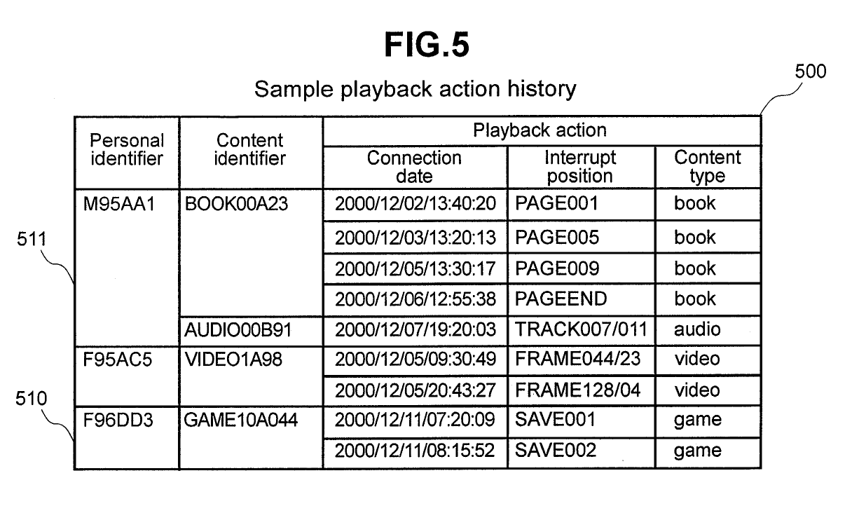

FIG. 5 shows a sample playback action history 500 stored in the playback action history management database 321. The playback action history 500 is digitized information containing a plurality of personal playback action histories 510 and includes a plurality of personal identifiers represented by strings and the like, content identifiers, and the history associated with playback actions for the contents identified by the content identifiers. The personal playback action history 510 contains at least 0 content identifiers for each personal identifier and at least one history information for each content identifier. It would also be practical to include personal information such as personal interests and information associated with system operations such as the time at which usage was begun. The history information contains a marking position that allows a playback start position in digital content to be identified. It would also be practical to include information such as date information and the terminal used for playback. The most recent history information associated with a content serves as the up-to-date information 511 in the personal playback action history for the content.

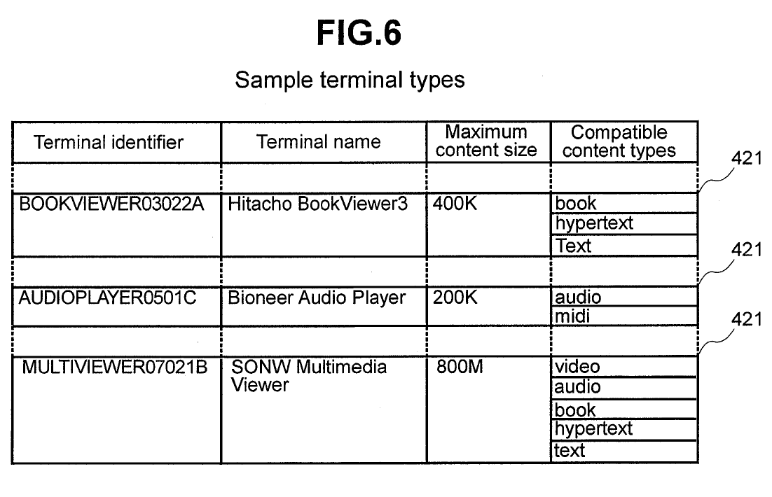

FIG. 6 is a sample terminal type 421. The terminal type 421 contains information that allows digital content types associated with playback on playback terminal devices. One or more content types can be included. For example, if a visual terminal device is a personal computer, playback of video content, playback of music content, and playback of other content is possible, so a plurality of content types is included. If the playback terminal device can only playback audio, e.g., through a speaker, only audio content playback would e included. The terminal type 421 can also include other information dependent on playback devices.

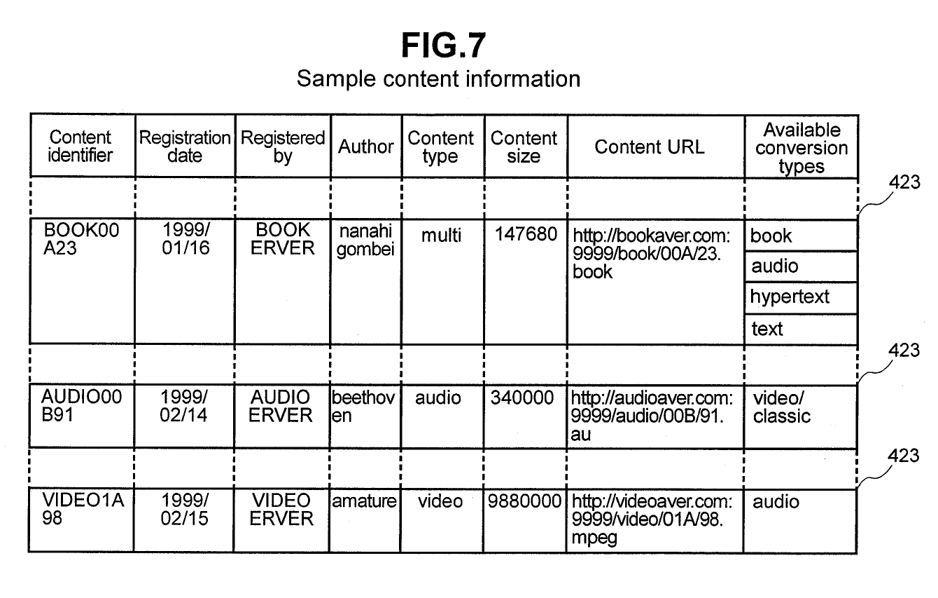

FIG. 7 shows sample content information 423 stored in the content information management database 323. Content information 423 is digital information associated with different types of content. The content information 423 includes a content identifier as well as information such as a string indicating content type, the content size, the address at which the content is stored, the types of contents into which conversion is possible, and the like. It would also be possible to include information such as content conversion rules.

The specific flow of operations in FIG. 5, FIG. 6, and FIG. 7 will be described according to the steps shown in FIG. 1.

As advance preparation, a personal identifier is registered in the playback data management device. For example, when a member's fee is collected at a digital comics cafe, a member ID such as M95AA1 is generated and is registered in the playback data management device as a personal identifier. This member ID is imprinted on a member card or the like or recorded internally if an IC card is used.

The user enters the member ID M95AA1 into the playback terminal device. The playback terminal device displays a list of digital contents and the user selects a content to be played back. The playback terminal device internally converts the selected content to a content identifier such as BOOK00A23. The personal identifier, the content identifier, and a terminal type that includes a terminal identifier written in ROM or a database inside the device such as BOOKVIEWER03022A is sent to the playback data management device. At the playback terminal device, it would be possible for the user to directly enter a content identifier instead of making a selection from a digital content list. For example, at a digital comics cafe, there can be a list of digital contents and content identifiers. The user would look at this list and directly enter identifiers into the playback terminal device.

At the playback data management server, the playback action history is searched for the personal identifier M95AA1 and the content identifier BOOK00A23, and playback actions associated with the user and the content are retrieved. If the search for BOOK00A23 fails, the playback is treated as the first time for that content. Also, content information and content are prepared based on the content identifier BOOK00A23.

At the playback data management device, the content is converted according to the terminal type. The terminal type is used to determine that the content types that can be received are book, hypertext, and text. The content information indicates that the content type is multi, which can be converted into the book, audio, hypertext, and text content types. Since this playback terminal device cannot receive the multi content type, conversion to book, hypertext, or text must be performed. In this example, conversion is performed to the book type.

At the playback data management device, playback start information is generated. Out of the playback actions, the interruption position PAGE001 is retrieved and converted according to the converted content type to serve as the playback start information. In this case, the content type of the interruption position is book and the converted content type is book so no conversion is needed.

The playback data management device sends the playback start information PAGE001 and the converted content in book format to the playback terminal device.

The playback terminal device plays back the received content based on the PAGE001 playback start information and receives playback operations from the user. If the user reads up to page 5 and stops, PAGE005 is generated as playback interruption information. The personal identifier M95AA1, the content identifier BOOK00A23, and the playback interruption information PAGE005 are sent to the playback data management device, and the playback data management device updates the playback action history.

According to this embodiment, continuation playback can be provided using content formats suited for playback terminals even if different playback terminals and different locations are involved.

For example, it would be possible to perform multimedia browsing at home via the Web using a personal computer, continue reading at a hospital using an electronic book terminal, and then continue while moving in a train using audio from an audio terminal.

Also, the playback action history can be used as statistical data. Services can be provided such as identifying individuals who frequently read romance novels so that these individuals can be notified when a new romance novel comes out or granting playback privileges for new content to users who played back a fixed number of contents.

A second embodiment will be described.

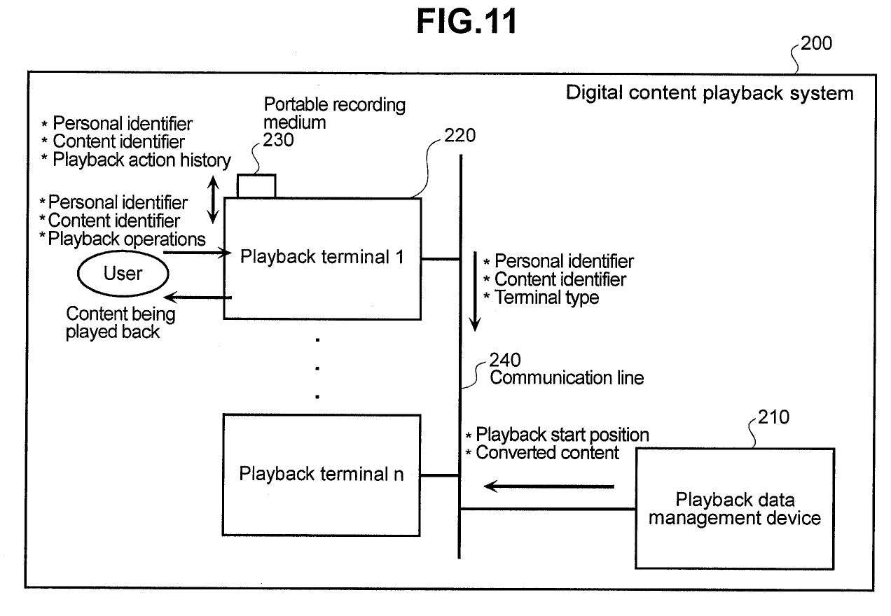

FIG. 11 is a simplified drawing showing the architecture of a digital content playback system according to this embodiment. This embodiment differs from the first embodiment shown in FIG. 2 in that the personal playback action history is stored in a portable medium connected to the playback terminal device.

The playback terminal device 220 receives a personal identifier and a content identifier from the user or the portable storage medium 230 and receives the personal playback action history from the portable storage medium 230. The playback terminal device 220 also provides the user with content and receives playback operations.

The playback data management device 210 receives the personal identifier, the content identifier, the personal playback action history, and the terminal type from the playback terminal device 220 via the communication line 240 and sends playback start information and converted content to the playback terminal device 220.

The portable storage medium 230 is a portable recording medium, e.g., an IC card or smart card, that can store digitized information. The portable storage medium 230 stores a personal identifier, a content identifier, and a personal playback action history. Personal information and the like can be stored as well.

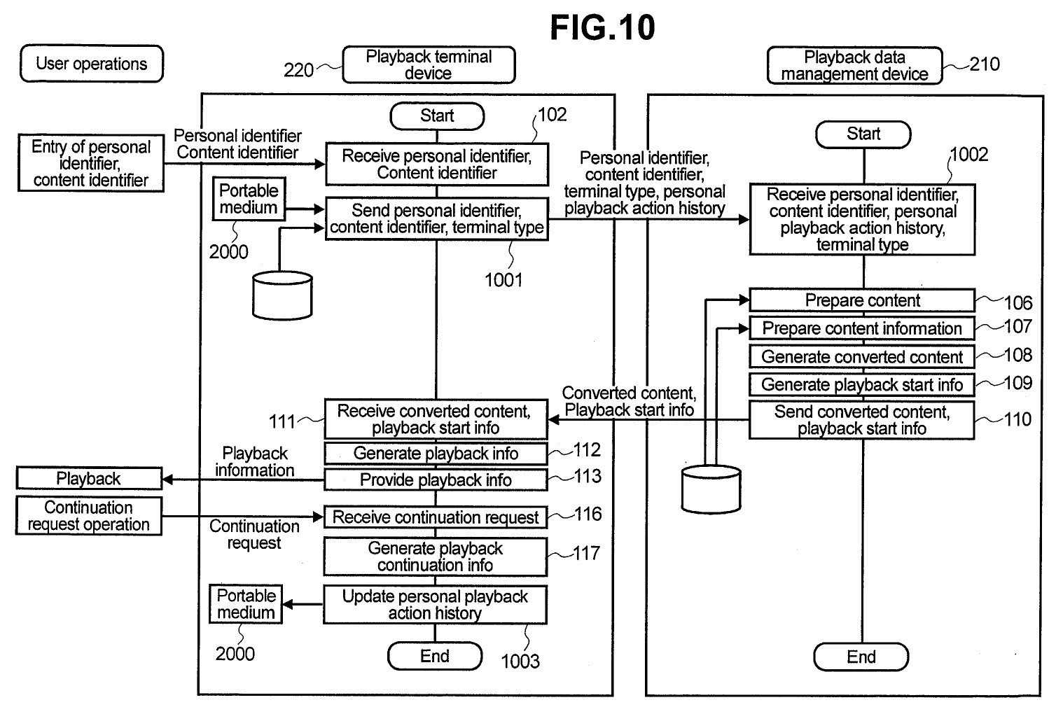

Next, the flow of operations will be described in detail using FIG. 10. FIG. 10 is a sequence diagram illustrating the series of operations taking place in a digital content playback system according to an embodiment of the present invention. This figure is almost identical to FIG. 1 except for the flow of operations involving the personal playback action history. The steps associated with this will be described.

Step 1001: In order to obtain playback start information, the playback terminal device 220 sends the personal identifier and the content identifier received from the user and the personal playback information history stored in the portable medium to the playback data management device 210 using the communication line 240. In certain cases, the terminal type 421 may also be sent to the playback data management device 210 in order to obtain converted content. In the architecture shown in FIG. 11, there is one server, but it would be possible to have multiple servers. If the content described above is to be sent starting with the start position, the personal playback information history does not need to be sent to the playback data management device 210.

Step 1002: The playback data management device 210 receives the personal identifier, the content identifier, and the personal playback action history from the playback terminal device 220 via the communication line 240. In some cases, the terminal type 421 is also received from the playback terminal device 220 via the communication line 240. The content associated with the content identifier is sent to the playback terminal device 220. Depending on the personal playback action history, the content sent can be content starting from a playback continuation position.

Step 1003: When user is done with the playback operation, the playback terminal device 220 updates the personal playback action history using the content identifier and the playback continuation information for the content that was played back. This history is stored in the portable medium.

As in the first embodiment, this embodiment allows continuation playback operations using content formats associated with playback terminals even if different locations and different playback terminals are involved.

Also, even if the playback data management device is different from the one used in the previous playback operation, if the same content is stored the content identifier can be used to read the stored content and playback of the same content can be continued from where the previous playback left off.

The present invention allows content playback to be resumed by a user in a different location, and content playback can be resumed at a different type of playback terminal.

What is claimed is:

1. In a digital content server, a method for delivering digital content to a terminal device, the method comprising:
receiving digital content identification information;
receiving terminal device information relating to said terminal device;
identifying specific digital content based on said digital content identification information;
obtaining digital content presentation capability information based on said terminal device information;
based on said digital content presentation capability information, determining whether said terminal device is capable of presenting said specific digital content to a user; and
if said specific digital content can be presented by said terminal device, then delivering said specific digital content to said terminal device.

2. The method of claim 1 wherein said step of delivering includes converting said specific digital content to produce converted specific digital content that is suitable for said terminal device.

3. The method of claim 2 wherein said converting includes ignoring one or more portions of said specific digital content.

4. The method of claim 1 further including receiving digital content delivery control information, and in response thereto altering delivery of said specific digital content in accordance with said digital content delivery control information.

5. A method for delivering digital content from a server system to a terminal device comprising:
receiving user identification information;
receiving digital content identification information;
receiving a terminal identification information which specifies a first terminal device;
identifying specific digital content based on said digital content information;
accessing position indication information based on said user identification information;
delivering said specific digital content to said first terminal device beginning from a starting position in said specific digital content indicated by said position indication, wherein said start position can be other than the beginning of the said specific digital content;
receiving a request to terminate delivery of said specific digital content;
if a portion of said specific digital content remains to be delivered to said first terminal device at the time of receiving said request, then modifying said position indication to indicate the beginning of said portion of said specific digital content,
whereby delivery of said portion of said specific digital content can resume at another time.

6. The method of claim 5 further including, subsequent to said receiving a request to terminate, receiving a second terminal identification information which identifies a second terminal device different from said first terminal device, delivering some or all of said portion of said specific digital content to said second terminal.

7. A method for delivering digital content comprising:
receiving a user identification, said user identifier having associated therewith position indication information;
receiving a terminal identifier;
receiving a digital content identifier;
accessing specific digital content at a first location depending on said position indication information;
determining if said specific digital content can be presented by a terminal device corresponding to said terminal identifier;
if said specific digital content can be presented by said terminal device, then delivering said specific digital content beginning from said first location;
receiving a request to terminate delivery of said specific digital content; and
in response to said request, updating said position indication information to indicate a second location in said specific digital content, said second location being the beginning of an undelivered portion of said specific digital content,
whereby said undelivered portion of said specific digital content can be delivered at a later time.

8. The method of claim 7 wherein said step of delivering includes converting said specific digital content to produce converted specific digital content that is suitable for said terminal device.

9. The method of claim 7 further including receiving digital content delivery control information, and in response thereto altering delivery of said specific digital content in accordance with said digital content delivery control information.

10. The method of claim 7 further including receiving a second terminal identifier corresponding to a second terminal device different from said terminal device and delivering at least some of said undelivered portion of said specific digital content to said second terminal device if said specific digital content can be presented by said second terminal device.

11. A digital content server comprising:
means for receiving user identification information and digital content identification information;
means for producing a position indication using said user identification information;
means for accessing specific digital content identified by said digital content identification information;
means for delivering said specific digital content to a terminal device, beginning from a location based on said position indication information;
means for receiving a request;
means for updating said position indication in response to receiving a request to terminate delivery of said specific digital content, wherein said position indication is represents the beginning of a remaining portion of said specific digital content that has not been delivered to said terminal device.

12. A device for delivering digital content comprising:
a communication module to transmit and receive information;
a digital content access module to access digital content, said digital content access module operable to access specific digital content in response to receiving digital content identification information; and
a delivery module coupled to receive digital content from said digital content access module and to selectively transmit said specific digital content via said communication module,
said delivery module, in response to receiving terminal device identification information, being operable to determine whether said specific digital content can be presented by a terminal device identified by said terminal device identification information,
said delivery module, in response to determining that said terminal device can present said specific digital content, being operable to deliver said specific digital content to said terminal device.

13. The device of claim 12 wherein said digital content access module includes a remote access module operable to access at least one remote data store to access digital content that is not locally stored.

14. The device of claim 12 further including a conversion module to convert said specific digital content to produce converted specific digital content that is suitable for said terminal device.

15. The device of claim 12 wherein said delivery module, in response to receiving delivery control information, is operable to alter the delivery of said specific digital content in accordance with said delivery control information.

16. A system for delivering digital content comprising:
a communication module to transmit and receive information;
a digital content access module to access digital content, said digital content access module operable to access specific digital content in response to receiving user identification information and digital content identification information; and
a delivery module coupled to receive digital content from said digital content access module and to transmit said specific digital content via said communication module,
said delivery module, in response to receiving terminal device identification information, being operable to transmit said specific digital content to a terminal device identified by said terminal device identification information, said specific digital content being transmitted starting at a first location determined by position information associated with said user identification information,
said delivery module, in response to receiving a pause request, being operable to change said position indication to indicate a second location which is the beginning of an untransmitted portion of said specific digital content,
whereby subsequent transmission of said untransmitted portion of said specific digital content can resume at said second location.

17. The system of claim 16 wherein said delivery module is operable to deliver at least a portion of said untransmitted portion to a second terminal device different from said terminal device in response to receiving a second terminal device identification information which identifies said second terminal device.

18. The apparatus of claim 16 wherein said digital content access module includes a remote access module operable to access at least one remote data store to access digital content that is not locally stored.

19. The apparatus of claim 16 further including a conversion module to convert said specific digital content to produce converted specific digital content that is suitable for said terminal device.

20. The apparatus of claim 16 wherein said delivery module, in response to receiving delivery control information, is operable to alter the delivery of said specific digital content in accordance with said delivery control information.
